(19) United States
(12) Patent Application Publication
(10) Pub. No.: US 2020/0055509 A1
(43) Pub. Date: Feb. 20, 2020

(54) Bistable Solenoid Valve for a Hydraulic Braking System and Corresponding Hydraulic Braking System

(71) Applicant: Robert Bosch GmbH, Stuttgart (DE)

(72) Inventors: Wolf Stahr, Abstatt (DE); Klaus Landesfeind, Bangalore (IN); Massimiliano Ambrosi, Abstatt (DE); Michael Eisenlauer, Affalterbach (DE); Edgar Kurz, Heilbronn-Horkheim (DE); Wolfgang Schuller, Cleebronn (DE)

(21) Appl. No.: 16/609,400

(22) PCT Filed: Apr. 5, 2018
(86) PCT No.: PCT/EP2018/058687

§ 371 Date: Oct. 29, 2019

(30) Foreign Application Priority Data
May 29, 2017 (DE) 10 2017 208 937.7

(51) Int. Cl. B60T 15/02; F16K 31/08; H01F 7/08; H01F 7/16

(52) U.S. Cl. CPC B60T 15/028; F16K 31/082; H01F 7/081; B60T 13/686; B60T 2270/10; B60T 2270/30; H01F 7/16

(57) ABSTRACT

A bistable solenoid valve for a hydraulic braking system includes a magnetic assembly, a guide sleeve, a stationary component fixedly arranged in the guide sleeve, and a valve armature axially movably arranged in the guide sleeve. The valve armature includes a permanent magnet that is polarized in the direction of motion thereof. The magnetic assembly is slid onto the stationary component and the guide sleeve, and the stationary component forms an axial stop for the valve armature. The valve armature is configured to be driven by a magnetic force from the magnetic assembly or from the permanent magnet so as to force a closing element into a valve seat during a closing motion and lift the closing element out of the valve seat during an opening motion. The valve armature has a magnet receptacle that holds the permanent magnet. A hydraulic braking system includes the bistable solenoid valve.

The invention starts from a bistable solenoid valve for a hydraulic braking system according to the preamble of independent patent claim 1. The present invention also provides a hydraulic braking system for a vehicle having at least one such bistable solenoid valve.

Known hydraulic vehicle braking systems have a master brake cylinder which can be actuated by means of muscle force, to which wheel brake cylinders of wheel brakes are hydraulically connected. Connection of the wheel brake cylinders is conventionally via a hydraulic unit, which comprises solenoid valves, hydraulic pumps and hydraulic accumulators and permits brake pressure regulation at each wheel individually. Such brake pressure regulations allow different safety systems to be produced, such as, for example, anti-lock braking systems (ABS), electronic stability programs (ESP) etc., and different safety functions to be performed, such as, for example, an anti-lock function, traction control (TCS) etc. Via the hydraulic unit, control and/or regulation operations in the anti-lock braking system (ABS) or in the traction control system (TCS) or in the electronic stability program system (ESP system) for pressure generation or pressure reduction in the corresponding wheel brakes can be carried out. For carrying out the control and/or regulation operations, the hydraulic unit comprises solenoid valves which, on the basis of the oppositely acting forces “magnetic force”, “spring force” and “hydraulic force”, can mostly be held in definite positions.

Moreover, it is known from the prior art to configure hydraulic vehicle braking systems as externally powered braking systems, that is to say to provide them with an external energy supply device which provides the energy necessary for service braking. The external energy supply device conventionally comprises a hydraulic pressure accumulator which is charged by a hydraulic pump. The muscle force exerted by a driver delivers a target value for the level of braking force. Only in the case of failure of the external energy supply device is the vehicle braking system actuated in emergency operation by the muscle force of the vehicle driver as so-called secondary braking. Also known are secondary braking systems in which part of the energy required for brake actuation comes from an external energy supply device and the remainder comes from the muscle force of the vehicle driver. Neither externally powered braking systems nor secondary braking systems require a brake booster.

From DE 10 2008 001 013 A1 there is known a hydraulic vehicle braking system having a muscle-force-actuatable master brake cylinder, to which wheel brake cylinders of wheel brakes are hydraulically connected, and having a hydraulic pressure source as an external energy supply device with which pressure can be applied hydraulically to the wheel brake cylinders for brake actuation. A pressure chamber of the master brake cylinder is thereby connected via a decoupling valve to a brake fluid reservoir, so that the pressure chamber can be switched without pressure. Brake actuation takes place as externally powered braking using the external energy supply device. A hydraulic pedal travel simulator is additionally integrated into the master brake cylinder and can be switched without pressure via a simulator valve.

From DE 33 05 833 A1 there is known a bistable solenoid valve of the generic type which has a field coil and an armature which plunges therein and which consists of permanently magnetic material, is polarized in its movement direction and forms a valve part. A magnetic-field conducting body projects into the field coil like a core and fills part of the length of the field coil. A further magnetic-field conducting body is arranged next to the end of the field coil in which the armature plunges and is in the form of an annular disk which surrounds the armature at a distance therefrom. When the field coil is not energized, forces act between the magnetic-field conducting bodies and the armature which move the armature into latching positions, or at least hold it in such positions, and thus ensure stable switching positions of the solenoid valve. In this solenoid valve, a spring which can bring the valve part into a predetermined latching position is not necessary.

### DISCLOSURE OF THE INVENTION

The bistable solenoid valve for a hydraulic braking system having the features of independent patent claim 1 has the advantage that, in a solenoid valve having a de-energized first operating state, a further de-energized second operating state can be implemented. This means that embodiments of the present invention provide a bistable solenoid valve which can be switched between the operating states by applying a switching signal, wherein the solenoid valve remains permanently in the respective operating state until the next switching signal. The first operating state can correspond a closed position of the solenoid valve and the second operating state can correspond to an open position of the solenoid valve. The change between the two operating states can be carried out, for example, by briefly energizing the active actuator of the magnet assembly or by applying a switching signal or current pulse to the magnet assembly. With such brief energization, the energy consumption can advantageously be reduced compared to a conventional solenoid valve with two operating states, which has only a de-energized first operating state and, for implementing the second energized operating state, must be energized for the duration of the second operating state. Embodiments of the bistable solenoid valve according to the invention can be based on a normally open solenoid valve or on a normally closed solenoid valve.

Alternatively, a bistable solenoid valve based on a normally closed solenoid valve can be switched from the open position into the closed position by briefly energizing the magnet assembly and then switched from the closed position into the open position when a holding pressure in the solenoid valve falls below a set pressure threshold value. Alternatively, a bistable solenoid valve based on a normally open solenoid valve can be switched from the closed position into the open position by briefly energizing the magnet assembly and then switched from the open position into the closed position when a fluid force in the solenoid valve falls below a set threshold value.

Embodiments of the present invention provide a bistable solenoid valve for a hydraulic braking system, having a magnet assembly and a guide sleeve in which a stationary component is fixedly arranged and a valve armature having a permanent magnet, which is polarized in its movement direction, is arranged in an axially displaceable manner. The magnet assembly is pushed onto the stationary component and the guide sleeve. The stationary component forms an axial stop for the valve armature. The valve armature can be driven by a magnetic force generated by the magnet assembly or by a magnetic force of the permanent magnet and pushes a closing element into a valve seat during a closing movement and lifts the closing element out of the valve seat during an opening movement. The valve armature has at its first end face facing the stationary component a magnet receiver which receives the permanent magnet.

There is additionally proposed a hydraulic braking system for a vehicle, having a hydraulic unit and a plurality of wheel brakes. The hydraulic unit has at least one brake circuit which comprises at least one solenoid valve and carries out brake pressure regulation at each wheel individually. The at least one brake circuit has at least one bistable solenoid valve.

In a hydraulic braking system, the use of bistable solenoid valves opens up possible savings by standardizing the valve types used and reducing the variety of variants of valve types in the kit for the hydraulic unit. Generally, and independently of the form of the braking system, the use of a bistable solenoid valve instead of a permanently energized solenoid valve brings possible savings by reducing the electrical energy requirement. In addition, briefly energizing the magnet assembly relieves the vehicle electrical system, and CO₂ emissions are reduced. Furthermore, it is possible to dispense with cost-intensive heat dissipation concepts in the electronic control device of the braking system. Moreover, fewer, or smaller, cooling elements, less heat-resistant materials and smaller distances between the components in the control device are possible, so that installation space can advantageously be saved.

By means of the measures and further developments mentioned in the dependent claims, advantageous improvements to the bistable solenoid valve for a hydraulic braking system described in independent patent claim 1 and to the hydraulic braking system described in independent patent claim 21 are possible.

In an advantageous further development of the invention, the bistable solenoid valve can be based on a normally closed solenoid valve. This means that the guide sleeve can be open at both ends, and the stationary component can be a pole body which closes the guide sleeve at a first end. In addition, the guide sleeve can be connected at a second end to a dome-shaped valve sleeve, at the bottom of which the valve seat can be formed at the edge of a through-opening. The stationary component, or the pole body, is preferably made of a ferromagnetic material.

In an advantageous form of the bistable solenoid valve, the permanent magnet can remain on the pole body in a de-energized open position of the solenoid valve, so that an air gap between the pole body and the valve armature is minimal and the closing element is lifted from the valve seat.

In a further advantageous form of the bistable solenoid valve, the magnet assembly can be energized during the closing movement with a first current direction, which generates a first magnetic field, which causes the pole body to repel the permanent magnet with the valve armature, so that the air gap between the valve armature and the pole body becomes larger and the closing element is pushed into the valve seat.

In a further advantageous form of the bistable solenoid valve, a return spring can be arranged between the pole body and the valve armature. Advantageously, a spring force of the return spring can assist the closing movement. In addition, in a de-energized closed position of the solenoid valve, a pressure confined in the solenoid valve and/or the return spring can hold the closing element in a sealing manner in the valve seat. Furthermore, the permanent magnet can move the valve armature in the direction towards the pole body during the opening movement, so that the air gap between the valve armature and the pole body becomes smaller and the closing element is lifted out of the valve seat when the pressure confined in the solenoid valve falls below a settable limit value. The effective spring force can be so set via the properties of the return spring that the solenoid valve remains in the closed position independently of the confined pressure and the effective magnetic force of the permanent magnet is equalized. In a form without a return spring, a pressure limit value can be set via the properties of the permanent magnet and the resulting magnetic force, and when the confined pressure in the solenoid valve falls below that set pressure limit value, the valve armature moves from the closed position into the open position. Alternatively, the resulting magnetic force of the permanent magnet can be set so small that the valve armature with the closing element remains in the closed position independently of the confined pressure.

In a further advantageous form of the bistable solenoid valve, the magnet assembly can be energized during the opening movement with a second current direction, which generates a second magnetic field, which causes the pole body and the permanent magnet with the valve armature to attract one another, so that the air gap between the valve armature and the pole body becomes smaller and the closing element is lifted out of the valve seat. In this embodiment, the properties of the permanent magnet are so chosen that the magnetic force of the permanent magnet is smaller than the acting closing force generated by the confined pressure and/or the return spring.

In an alternative advantageous further development of the invention, the bistable solenoid valve can be based on a normally open solenoid valve. This means that the guide sleeve can be in the form of a capsule which is open at one end, and the stationary component can be a valve insert having a through-opening, onto which the guide sleeve can be pushed with its open end. The stationary component, or the pole body, is preferably made of a ferromagnetic material. The valve armature can thereby be arranged between the valve insert and the closed end of the guide sleeve and can have at its first end face a plunger which can be guided in the through-bore of the valve insert and on the side of which remote from the valve armature the closing element can be arranged. In addition, at a second end of the valve insert a dome-shaped valve sleeve can be inserted into the through-opening, at the closed end of which the valve seat can be formed at the edge of a through-opening.

In a further advantageous form of the bistable solenoid valve, the permanent magnet can remain on the valve insert in a de-energized closed position of the solenoid valve, so that an air gap between the valve insert and the valve armature is minimal and the closing element is able to rest in the valve seat in a sealing manner.

In a further advantageous form of the bistable solenoid valve, the magnet assembly can be energized during the opening movement with the second current direction, which can generate the second magnetic field, which causes the valve insert to repel the permanent magnet with the valve armature, so that the air gap between the valve armature and the valve insert can become larger, and the closing element can be lifted from the valve seat.

In a further advantageous form of the bistable solenoid valve, a return spring can be arranged in the through-bore of the valve insert, which return spring can be supported at one end on a spring seat and at the other end can act via the plunger on the valve armature, so that a spring force of the return spring is able to assist the opening movement. In addition, in a de-energized open position of the solenoid valve, a fluidic force acting in the solenoid valve and/or the return spring can hold the closing element in the position lifted from the valve seat. Furthermore, the permanent magnet can move the valve armature during the closing movement in the direction towards the valve insert when the fluidic force acting in the solenoid valve falls below a settable limit value, so that the air gap between the valve armature and the valve insert can become smaller and the closing element can be pushed into the valve seat. The effective spring force can be so set via the properties of the return spring that the solenoid valve remains in the open position independently of the acting fluidic force and the effective magnetic force of the permanent magnet is equalized. In a form without a return spring, a limit value for the fluidic force can be set via the properties of the permanent magnet and the resulting magnetic force, and when the fluidic force falls below that limit value, the valve armature moves from the open position into the closed position. Alternatively, the resulting magnetic force of the permanent magnet can be set so small that the magnetic force of the permanent magnet is smaller than the acting opening force which is produced by the acting fluid force and/or the return spring, and the valve armature with the closing element remains in the open position independently of the acting fluidic force.

In a further advantageous form of the bistable solenoid valve, the magnet assembly can be energized during the closing movement with the first current direction, which can generate the first magnetic field, which causes the valve insert and the permanent magnet with the valve armature to attract one another, so that the air gap between the valve armature and the valve insert can be made smaller and the closing element can be pushed into the valve seat.

In a further advantageous form of the bistable solenoid valve, the permanent magnet can be arranged in the magnet assembly independently of the armature stroke. As a result, the permanent magnet, on energization of the magnet assembly, is always within the range of action of the magnetic field generated by the magnet assembly and can thus advantageously have smaller dimensions.

In an advantageous form of the hydraulic braking system, the at least one bistable solenoid valve in the de-energized open position can release a brake pressure regulation in at least one associated wheel brake and in the de-energized closed position can enclose a current brake pressure in the at least one associated wheel brake. As a result, with little additional outlay, there can be achieved in a hydraulic unit with ESP functionality, which is present in most cases, an additional function which can electro-hydraulically enclose a current brake pressure in the corresponding wheel brake and maintain it, with a small energy requirement, over a prolonged period. This means that the existing pressure supply, the pipelines from the hydraulic unit to the wheel brakes as well as sensor and communication signals can be used not only for the ESP function and/or ABS function and/or TCS function, but also for an electro-hydraulic pressure maintaining function in the wheel brakes. As a result, costs, installation space, weight and cabling can advantageously be saved, with the positive effect that the complexity of the braking system is reduced.

In a further advantageous form of the hydraulic braking system, the at least one brake circuit can comprise a fluid pump, a suction valve, which during brake pressure regulation connects a suction line of the fluid pump with a muscle-force-actuated master brake cylinder and in normal operation isolates the suction line of the fluid pump from the muscle-force-actuated master brake cylinder, and a changeover valve which in normal operation connects the muscle-force-actuated master brake cylinder with at least one associated wheel brake and during brake pressure regulation maintains the system pressure in the brake circuit. The changeover valve and/or the suction valve can here be in the form of a bistable solenoid valve.

In an alternative form of the hydraulic braking system, the at least one brake circuit can have a hydraulic pressure generator, the pressure of which can be set via a servomotor, a simulator valve, which in normal operation connects a pedal simulator with a muscle-force-actuated master brake cylinder and in emergency operation and during brake pressure regulation isolates the pedal simulator from the master brake cylinder, a brake circuit isolating valve, which in emergency operation connects the muscle-force-actuated master brake cylinder with at least one associated wheel brake and in normal operation and during brake pressure regulation isolates the muscle-force-actuated master brake cylinder from the at least one associated wheel brake, and a pressure switching valve, which in normal operation and during brake pressure regulation connects the hydraulic pressure generator with the at least one associated wheel brake and in emergency operation isolates the hydraulic pressure generator from the at least one associated wheel brake. The simulator valve and/or the brake circuit isolating valve and/or the pressure switching valve can here be in the form of a bistable solenoid valve.

Exemplary embodiments of the invention are shown in the drawing and will be explained in greater detail in the following description. In the drawing, identical reference numerals denote components or elements which perform the same or analogous functions.

### BRIEF DESCRIPTION OF THE DRAWINGS

FIG. 1 shows a schematic sectional representation of a first exemplary embodiment of a bistable solenoid valve according to the invention in the open position.

FIG. 2 shows a schematic sectional representation of the bistable solenoid valve according to the invention of FIG. 1 during the closing movement.

FIG. 3 shows a schematic sectional representation of the bistable solenoid valve according to the invention of FIGS. 1 and 2 in the closed position.

FIG. 4 shows a schematic sectional representation of the bistable solenoid valve according to the invention of FIGS. 1 to 3 during the opening movement.

FIG. 5 shows a schematic sectional representation of a second exemplary embodiment of a bistable solenoid valve according to the invention in the closed position.

FIG. 6 shows a schematic sectional representation of a third exemplary embodiment of a bistable solenoid valve according to the invention in the open position.

FIG. 7 shows a schematic circuit diagram of a first exemplary embodiment of a hydraulic braking system according to the invention.

FIG. 8 shows a schematic circuit diagram of a second exemplary embodiment of a hydraulic braking system according to the invention.

### EMBODIMENTS OF THE INVENTION

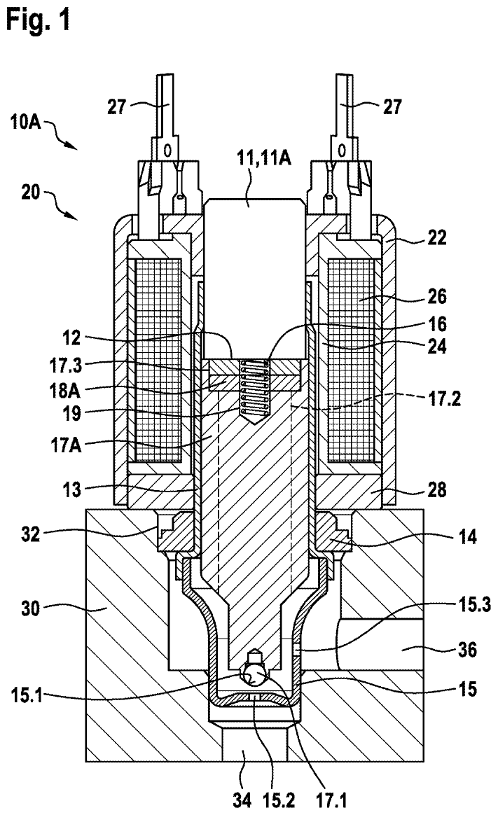

As can be seen from FIGS. 1 to 6, the exemplary embodiments shown of a bistable solenoid valve 10A, 10B, 10C according to the invention for a hydraulic braking system 1A, 1B comprise in each case a magnet assembly 20, 20C and a guide sleeve 13, 13C in which a stationary component 11 is fixedly arranged and a valve armature 17A, 17B, 17C having a permanent magnet 18A, 18B, 18C, which is polarized in its movement direction, is arranged to be axially displaceable. The magnet assembly 20, 20C is pushed onto the stationary component 11 and the guide sleeve 13, 13C. The stationary component 11 forms an axial stop for the valve armature 17A, 17B, 17C. The valve armature 17A, 17B, 17C can additionally be driven by a magnetic force generated by the magnet assembly 20, 20C or by a magnetic force of the permanent magnet 18A, 18B, 18C and pushes a closing element 17.1, 17.1C into a valve seat 15.1, 15.1C during a closing movement and lifts the closing element 17.1, 17.1C out of the valve seat 15.1, 15.1C during an opening movement. The valve armature 17A, 17B, 17C has at its first end face facing the stationary component 11 a magnet receiver 17.3, 17.3C which receives the permanent magnet 18A, 18B.

As can further be seen from FIGS. 1 to 5, the bistable solenoid valve 10A, 10B in both the exemplary embodiments shown is based on a normally closed solenoid valve. This means that the guide sleeve 13 is open at both ends, and the stationary component 11 is a pole body 11A, 11B of a ferromagnetic material which closes the guide sleeve 13 at a first end. In addition, there is connected to a second end of the guide sleeve 13 a hat-shaped valve sleeve 15 having a valve seat 15.1, which is arranged between at least one first flow opening 15.2 and at least one second flow opening 15.3. The solenoid valve 10A, 10B is fixed into place via a fixing disk 14 having a receiving bore 32 of a fluid block 30, which has a plurality of fluid channels 34, 36. As can further be seen from FIGS. 1 to 5, a first flow opening 15.2, at the inner edge of which the valve seat 15.1 is formed, is introduced into a bottom of the hat-shaped valve sleeve 15 and fluidically connected with a first fluid channel 34. The at least one second flow opening 15.3 is introduced in the form of a radial bore into the lateral surface of the hat-shaped valve sleeve 15 and is fluidically connected with a second fluid channel 36.

As can further be seen from FIGS. 1 to 5, the closing element 17.1 in the exemplary embodiments shown is in the form of a ball and is pressed into a receiver in the valve armature 17A, 17B, which is arranged on a second end face of the valve armature 17A, 17B facing the valve seat 15.1. The valve armature 17A, 17B additionally comprises a plurality of equalizing grooves 17.2 in the form of axial grooves, which permit pressure equalization between the first and second end faces of the valve armature 17A, 17B.

As can further be seen from FIGS. 1 to 5, the magnet assembly 20 in the exemplary embodiment shown comprises a dome-shaped housing casing 22, a winding body 24, on which a coil winding 26 is applied, and a cover plate 28, which closes the dome-shaped housing casing 22 on its open side. The coil winding 26 can be energized via two electrical contacts 27, which are guided out of the housing casing 22. As can further be seen from FIGS. 1 to 5, the permanent magnet 18A, 18B is arranged inside the magnet assembly 20 independently of the armature stroke.

As can further be seen from FIGS. 1 to 4, in the first exemplary embodiment shown of a bistable solenoid valve 10A, a return spring 16 is arranged between the pole body 11A and the valve armature 17A. A spring force of the return spring 16 can hereby assist the closing movement of the valve armature 17A or of the closing element 17.1. As can further be seen from FIGS. 1 to 4, the return spring 16 in the exemplary embodiment shown is received at least in part by a spring receiver 19, which is introduced in the form of a bore into the valve armature 17A. In the exemplary embodiment shown, the permanent magnet 18A is in the form of a circular perforated disk, through which the return spring 16 passes. Alternatively, the permanent magnet 18A can be in the form of a square perforated plate. In an alternative exemplary embodiment which is not shown, the spring receiver 19 can be introduced in the form of a bore into the pole body 11A. In this exemplary embodiment, the permanent magnet 18A can then be in the form of a disk or plate without a hole. In addition, both the pole body 11A and the valve armature 17A can have a spring receiver 19 which receive the return spring 16 at least in part.

As can further be seen from FIG. 1, the permanent magnet 18A remains on the pole body 11A in the de-energized open position of the solenoid valve 10A that is shown, so that an air gap 12 between the pole body 11A and the valve armature 17A is minimal and the closing element 17.1 is lifted from the valve seat 15.1.

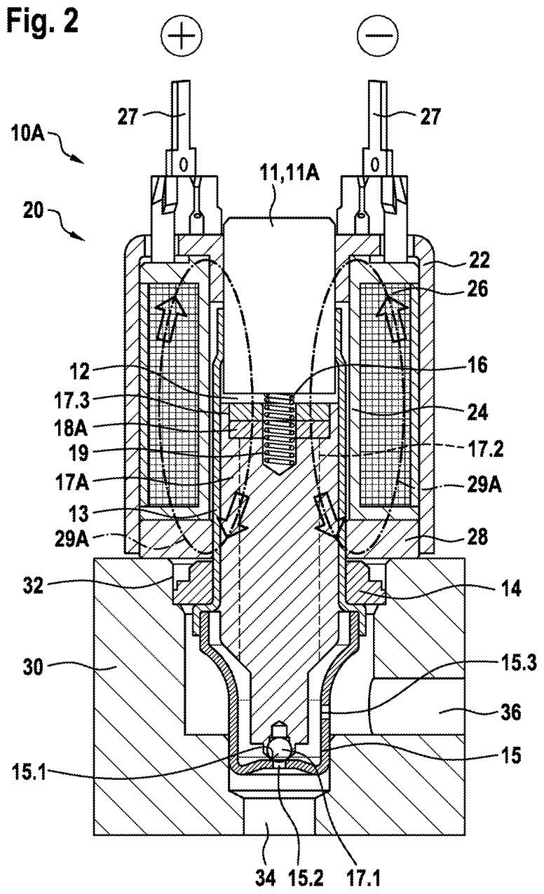

As can further be seen from FIG. 2, for closing the solenoid valve 10A, the magnet assembly 20 is energized during the closing movement with a first current direction, which generates a first magnetic field 29A, which causes the pole body 11A to repel the permanent magnet 18A with the valve armature 17A, so that the air gap 12 between the valve armature 17A and the pole body 11A becomes larger and the closing element 17.1 is pushed into the valve seat 15.1. In addition, the spring force of the return spring 16 assists the closing movement of the valve armature 17A or of the closing element 17.1.

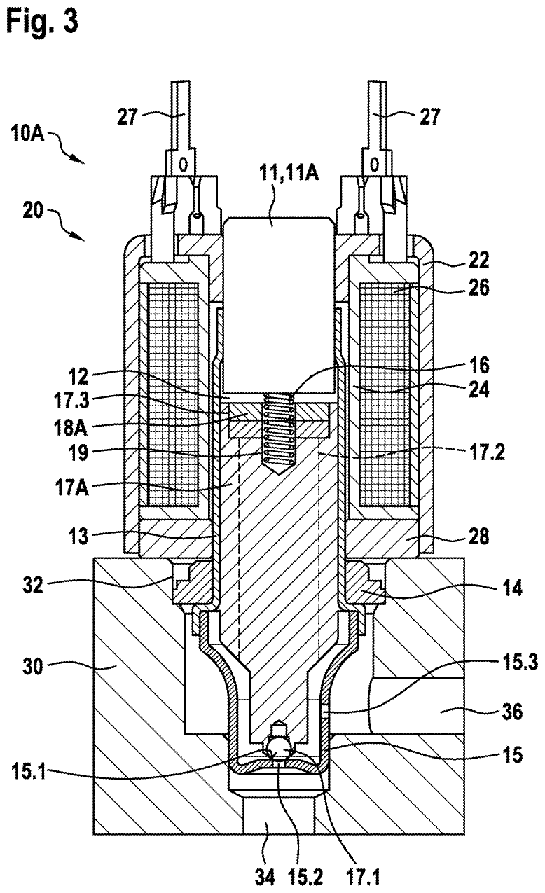

As can further be seen from FIG. 3, in the exemplary embodiment shown, after the current through the magnet assembly 20 has been switched off, a pressure confined in the solenoid valve 10A and the return spring 16 hold the closing element 17.1 in a sealing manner in the valve seat 15.1. In the exemplary embodiment shown, the magnetic force of the permanent magnet 18A is smaller than the acting closing force generated by the confined pressure and/or the return spring 16.

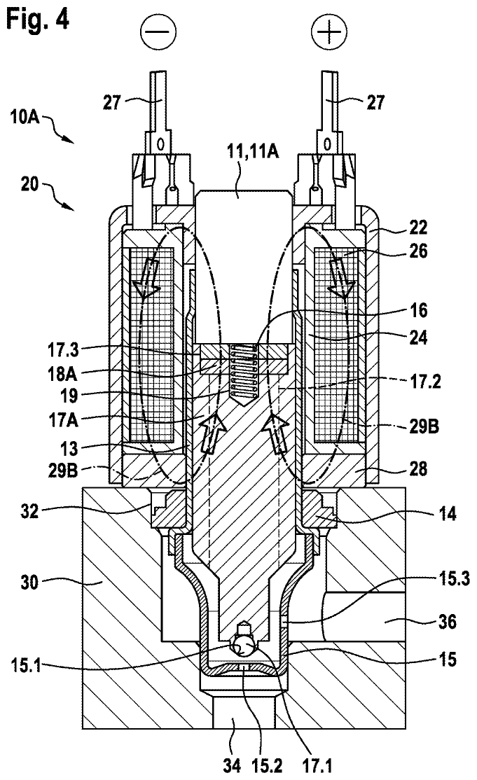

As can further be seen from FIG. 4, for opening the solenoid valve 10A, the magnet assembly 20 is energized during the opening movement with a second current direction, which generates a second magnetic field 29B, which causes the pole body 11A and the permanent magnet 18A with valve armature 17A to attract one another, so that the air gap 12 between the valve armature 17A and the pole body 11A becomes smaller and the closing element 17.1 is lifted out of the valve seat 15.1. This means that the polarity of the current flow through the magnet assembly 20 is simply reversed on opening of the solenoid valve 10A as compared to closing of the solenoid valve 10A.

Alternatively, the magnetic force of the permanent magnet 18A can be so set that, for opening the solenoid valve 10A, the permanent magnet 18A moves the valve armature 17A in the direction towards the pole body 11A during the opening movement, when the pressure confined in the solenoid valve 10A falls below a settable limit value, so that the air gap 12 between the valve armature 17A and the pole body 11A becomes smaller and the closing element 17.1 is lifted out of the valve seat 15.1. In this embodiment, the solenoid valve 10A changes from the closed position into the open position without energization of the magnet assembly 20 in dependence on the effective hydraulic force, or the confined pressure. This means that the magnetic force of the permanent magnet 18A is greater than the acting closing force generated by the confined pressure and/or the return spring 16 when the confined pressure falls below the set limit value.

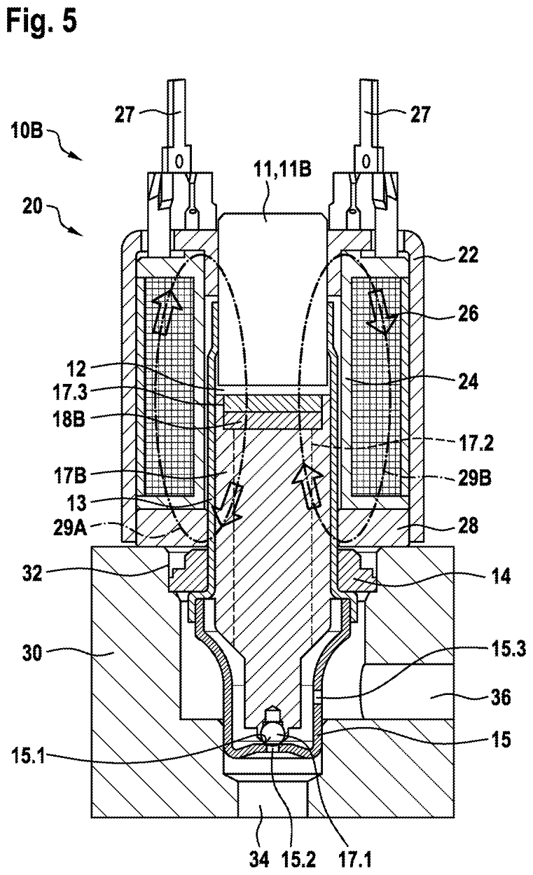

As can further be seen from FIG. 5, in the second exemplary embodiment of a bistable solenoid valve 10B that is shown, in contrast to the first exemplary embodiment of the bistable solenoid valve 10B, there is no return spring 16 arranged between the pole body 11B and the valve armature 17B. In the exemplary embodiment shown, the permanent magnet 18B is in the form of a circular disk. Alternatively, the permanent magnet 18B can be in the form of a square plate.

Analogously to the first exemplary embodiment, the permanent magnet 18B remains on the pole body 11B in the de-energized open position of the solenoid valve 10B, so that the air gap 12 between the pole body 11B and the valve armature 17B is minimal and the closing element 17.1 is lifted from the valve seat 15.1. For closing, the magnet assembly 20 of the solenoid valve 10B energized with a first current direction during the closing movement, which generates the first magnetic field 29A shown on the left in FIG. 5, which causes the pole body 11B to repel the permanent magnet 18B with the valve armature 17B, so that the air gap 12 between the valve armature 17B and the pole body 11B becomes larger and the closing element 17.1 is pushed into the valve seat 15.1. After the current through the magnet assembly 20 has been switched off, a pressure confined in the solenoid valve 10B holds the closing element 17.1 in a sealing manner in the valve seat 15.1. For opening the solenoid valve 10B, the magnet assembly 20 is energized with a second current direction during the opening movement, which generates the second magnetic field 29B shown on the right in FIG. 5, which causes the pole body 11B and the permanent magnet 18B with the valve armature 17B to attract one another, so that the air gap 12 between the valve armature 17B and the pole body 11B becomes smaller and the closing element 17.1 is lifted out of the valve seat 15.1.

Alternatively, the magnetic force of the permanent magnet 18B can be so set that, for opening the solenoid valve 10B, the permanent magnet 18B moves the valve armature 17B in the direction towards the pole body 11B during the opening movement, when the pressure confined in the solenoid valve 10B falls below a settable limit value, so that the air gap 12 between the valve armature 17B and the pole body 11B becomes smaller and the closing element 17.1 is lifted out of the valve seat 15.1. In this embodiment, the solenoid valve 10B changes from the closed position into the open position without energization of the magnet assembly 20 in dependence on the effective hydraulic force, or the confined pressure. This means that the magnetic force of the permanent magnet 18B is greater than the acting closing force generated by the confined pressure when the confined pressure falls below the set limit value.

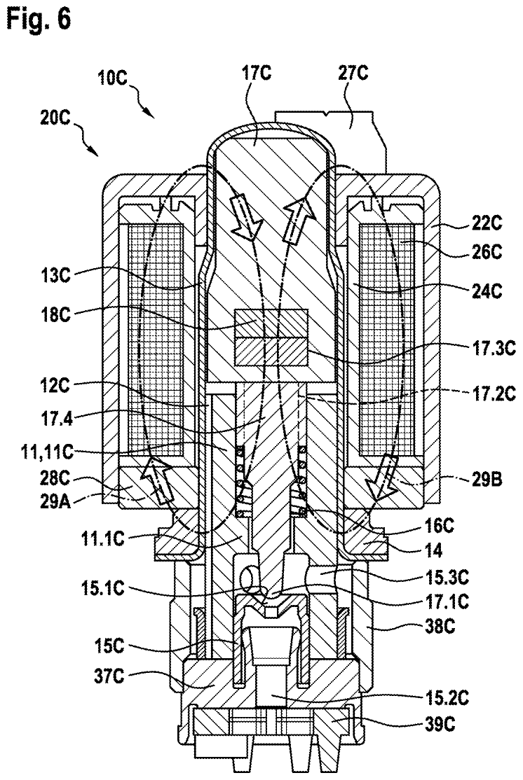

As can further be seen from FIG. 6, the bistable solenoid valve 10C in the third exemplary embodiment shown is based on a normally open solenoid valve. This means that the guide sleeve 13C is in the form of a capsule which is open at one end, and the stationary component 11 is a valve insert 11C of a ferromagnetic material with a through-opening, onto which the guide sleeve 13C is pushed or pressed with its open end. As can further be seen from FIG. 6, the valve armature 17C is arranged between the valve insert 11C and the closed end of the guide sleeve 13C. In addition, the valve armature 17C has at its first end face a plunger 17.4C, which is guided in the through-bore of the valve insert 11C. The closing element 17.1C is arranged on the side of the plunger 17.4C that is remote from the valve armature 17C. In the third exemplary embodiment shown, the closing element 17.1C is in the form of a spherical projection. In addition, the plunger 17.4C comprises a plurality of equalizing grooves 17.2C in the form of axial grooves, which permit pressure equalization between the end face of the plunger 17.4C facing the valve seat 15.1C and an air gap 12C between the valve armature 17C and the valve insert 11C. At a second end of the valve insert 11C, a dome-shaped valve sleeve 15C is inserted into the through-opening, at the closed end of which the valve seat 15.1C is formed at the edge of a through-opening. The valve seat 15.1C is arranged between at least one first flow opening 15.2C and at least one second flow opening 15.3C. The solenoid valve 10C is fixed in place via a fixing disk 14 to a receiving bore, not shown in FIG. 6, of a fluid block which has a plurality of fluid channels. As can further be seen from FIG. 6, a first flow opening 15.2 is arranged at a valve bottom portion 37C having a flat filter 39C and is continued through the dome-shaped valve sleeve 15C and the through-bore, at the inner edge of which the valve seat 15.1C is formed. The at least one second flow opening 15.3 is introduced in the form of a radial bore into the lateral surface of the valve insert 11C. A radial filter 38C is arranged in the region of the second flow openings.

As can further be seen from FIG. 6, the magnet assembly 20C in the exemplary embodiment shown, analogously to the magnet assembly 20 from FIGS. 1 to 5, comprises a dome-shaped housing casing 22C, a winding body 24C, on which a coil winding 26C is applied, and a cover disk 28C, which closes the dome-shaped housing casing 22C on its open side. The coil winding 26C can be energized via two electrical contacts 27C, which are guided out of the housing casing 22C. In FIG. 6, only one of the electrical contacts 27C is visible. As can further be seen from FIG. 6, the permanent magnet 18C is arranged inside the magnet assembly 20C independently of the armature stroke.

As can further be seen from FIG. 6, in the third exemplary embodiment shown of a bistable solenoid valve 10C, there is arranged in the through-bore of the valve insert 11C a return spring 16C, which is supported at one end on a spring receiver 11.1C and acts at the other end on the valve armature 17C via the plunger 17.4, so that a spring force of the return spring 16C assists the opening movement of the valve armature 17C, or of the closing element 17.1C. As can further be seen from FIG. 6, the spring receiver 11.1C is integrally formed with the valve insert 11C. Alternatively, the spring receiver can be in the form of a ring which is pushed into the through-bore of the valve insert 11C. In the third exemplary embodiment shown, the permanent magnet 18C is in the form of a disk or in the form of a plate without a hole. In an exemplary embodiment of a bistable solenoid valve which is not shown, in contrast to the third exemplary embodiment of the bistable solenoid valve 10C there is no return spring 16C arranged between the valve insert 11C and the valve armature 17C.

As can further be seen from FIG. 6, in the de-energized open position of the solenoid valve 10C shown, a hydraulic force acting in the solenoid valve 10C and/or the return spring 16C holds the closing element 17.1C in the position lifted from the valve seat 15.1C, so that the air gap 12C between the valve insert 11C and the valve armature 17C is maximum and the closing element 17.1C is lifted from the valve seat 15.1C.

As can further be seen from FIG. 6, for closing the solenoid valve 10C, the magnet assembly 20 is energized during the closing movement with the first current direction, which generates the first magnetic field 29A shown on the left in FIG. 6, which causes the valve insert 11C and the permanent magnet 18C with the valve armature 17C to attract one another, so that the air gap 12C between the valve armature 17C and the valve insert 11C becomes smaller and the closing element 17.1C is pushed into the valve seat 15.1C. The closing movement of the valve armature 17C, or of the closing element 17.1C, takes place against the spring force of the return spring 16C and/or the effective hydraulic force in the solenoid valve 10C. In the exemplary embodiment shown, the magnetic force of the permanent magnet 18C is smaller than the acting opening force generated by the hydraulic force and/or the spring force of the return spring 16. In the de-energized closed position of the bistable solenoid valve 10C, which is not shown, the permanent magnet 18C remains on the valve insert 11C, so that the air gap 12C between the valve insert 11C and the valve armature 17B is minimal and the closing element 17.1 is pushed in a sealing manner into the valve seat 15.1.

Alternatively, the magnetic force of the permanent magnet 18C can be so set that, for closing the solenoid valve 10C, the permanent magnet 18C moves the valve armature 17C during the closing movement in the direction towards the valve insert 11C, when the hydraulic force acting in the solenoid valve 10C falls below a settable limit value, so that the air gap 12C between the valve armature 17C and the valve insert 11C becomes smaller and the closing element 17.1C is pushed into the valve seat 15.1C. In this embodiment, the solenoid valve 10C changes from the open position into the closed position without energization of the magnet assembly 20C in dependence on the effective hydraulic force. This means that the magnetic force of the permanent magnet 18C is greater than the acting opening force generated by the effective hydraulic force and/or the return spring 16C, when the effective hydraulic force falls below the set limit value.

As can further be seen from FIG. 6, for opening the solenoid valve 10C, the magnet assembly 20C is energized with the second current direction during the opening movement, which generates the second magnetic field 29B shown on the right in FIG. 6, which causes the valve insert 11C to repel the permanent magnet 18C with the valve armature 17C, so that the air gap 12C between the valve armature 17C and the valve insert 11C becomes larger and the closing element 17.1C is lifted from the valve seat 15.1C. This means that the polarity of the current flow through the magnet assembly 20C on opening of the solenoid valve 10C is simply reversed in comparison to the closing of the solenoid valve 10C.

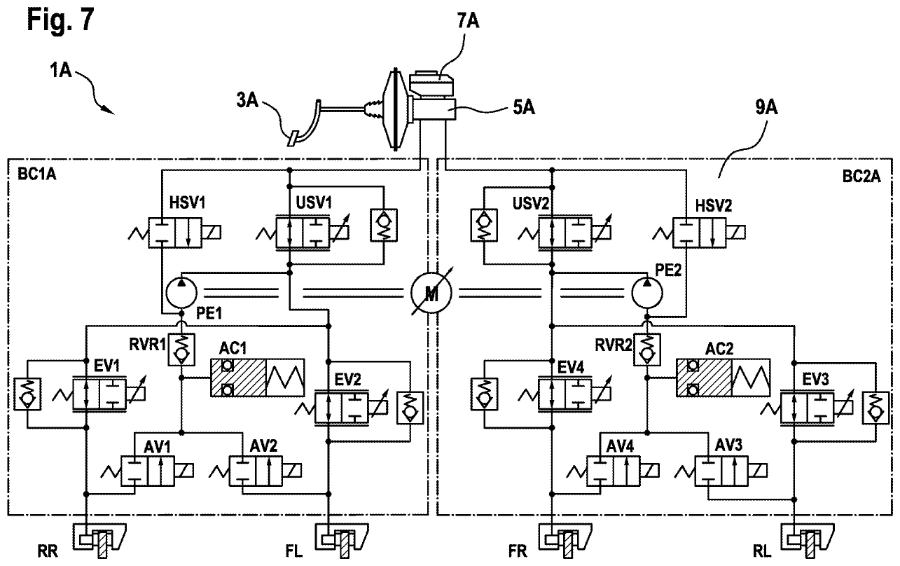

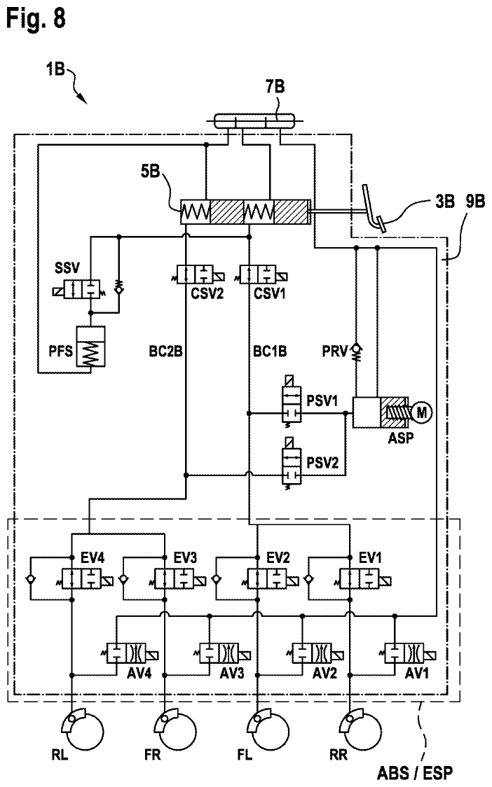

As can further be seen from FIGS. 7 and 8, the exemplary embodiments shown of a hydraulic braking system 1A, 1B for a vehicle comprise in each case a hydraulic unit 9A, 9B and a plurality of wheel brakes RR, FL, FR, RL. The hydraulic unit 9A, 9B has at least one brake circuit BC1A, BC2A, BC1B, BC2B, which comprises at least one solenoid valve HSV1, HSV2, USV1, USV2, EV1, EV2, EV3, EV4, AV1, AV2, AV3, AV4, SSV, CSV1, CSV2, PSVT, PSV2, TSV and carries out brake pressure regulation for each wheel individually. The at least one brake circuit BC1A, BC2A, BC1B, BC2B here has at least one bistable solenoid valve 10A, 10B, 10C.

As can be seen from FIGS. 7 and 8, the exemplary embodiments shown of a hydraulic braking system 1A, 1B according to the invention for a vehicle, with which various safety functions can be performed, comprise in each case a master brake cylinder 5A, 5B, a hydraulic unit 9A, 9B and a plurality of wheel brakes RR, FL, FR, RL. As can further be seen from FIGS. 7 and 8, the exemplary embodiment shown of the hydraulic brake system 1A, 1B in each case comprise two brake circuits BC1A, BC2A, BC1B, BC2B, with each of which there are associated two of the four wheel brakes RR, FL, FR, RL. Thus, a first wheel brake RR, which is arranged, for example, on a vehicle rear axle on the right-hand side, and a second wheel brake FL, which is arranged, for example, on the vehicle front axle on the left-hand side, are associated with a first brake circuit BC1A, BC1B. A third wheel brake FR, which is arranged, for example, on a vehicle front axle on the right-hand side, and a fourth wheel brake RL, which is arranged, for example, on a vehicle rear axle on the left-hand side, are associated with a second brake circuit BC2A, BC2B. Each wheel brake RR, FL, FR, RL has an associated inlet valve EV1, EV2, EV3, EV4 and an associated outlet valve AV1, AV2, AV3, AV4, wherein pressure can be generated via the inlet valves EV1, EV2, EV3, EV4 in the corresponding wheel brake RR, FL, FR, RL, and wherein pressure can be reduced via the outlet valves AV1, AV2, AV3, AV4 in the corresponding wheel brake RR, FL, FR, RL. For generating pressure in the respective wheel brake RR, FL, FR, RL, the corresponding inlet valve EV1, EV2, EV3, EV4 is opened and the corresponding outlet valve AV1, AV2, AV3, AV4 is closed. For reducing pressure in the respective wheel brake RR, FL, FR, RL, the corresponding inlet valve EV1, EV2, EV3, EV4 is closed and the corresponding outlet valve AV1, AV2, AV3, AV4 is opened.

As can further be seen from FIGS. 7 and 8, a first inlet valve EV1 and a first outlet valve AV1 are associated with the first wheel brake RR, a second inlet valve EV2 and a second outlet valve AV2 are associated with the second wheel brake FL, a third inlet valve EV3 and a third outlet valve AV3 are associated with the third wheel brake FR, and a fourth inlet valve EV4 and a fourth outlet valve AV4 are associated with the fourth wheel brake RL. Via the inlet valves EV1, EV2, EV3, EV4 and the outlet valves AV1, AV2, AV3, AV4, control and/or regulating operations for implementing safety functions can be carried out.

As can further be seen from FIG. 7, in the first exemplary embodiment of the hydraulic braking system 1A, the first brake circuit BC1A has a first suction valve HSV1, a first changeover valve USV1, a first equalizing container AC1 with a first non-return valve RVR1, and a first fluid pump RFP1. The second brake circuit BC2A has a second suction valve HSV2, a second changeover valve USV2, a second equalizing container AC2 with a second non-return valve RVR2, and a second fluid pump RFP2, wherein the first and second fluid pumps RFP1, RFP2 are driven by a common electric motor M. Furthermore, the hydraulic unit 9A for determining the current system pressure or brake pressure comprises a sensor unit 9.1. For brake pressure regulation and for implementing a TCS function and/or an ESP function, the hydraulic unit 9A uses in the first brake circuit BC1A the first changeover valve USV1, the first suction valve HSV1 and the first return pump RFP1 and in the second brake circuit BC2A the second changeover valve USV2, the second suction valve HSV2 and the second return pump RFP2. As can further be seen from FIG. 7, each brake circuit BC1A, BC2A is connected with the master brake cylinder 5A, which can be actuated via a brake pedal 3A. In addition, a fluid container 7A is connected with the master brake cylinder 5A. The suction valves HSV1, HSV2 allow intervention in the braking system without a driver command being present. To that end, the respective suction path for the corresponding fluid pump RFP1, RFP2 to the master brake cylinder 5A is opened via the suction valves HSV1, HSV2, so that it, instead of the driver, can supply the required pressure for the regulation. The changeover valves USV1, USV2 are arranged between the master brake cylinder 5A and at least one associated wheel brake RR, FL, FR, RL and set the system pressure or brake pressure in the associated brake circuit BC1A, BC2A. As can further be seen from FIG. 7, a first changeover valve USV1 sets the system pressure or brake pressure in the first brake circuit BC1A and a second changeover valve USV2 sets the system pressure or brake pressure in the second brake circuit BC2A.

The at least two brake circuits BC1A, BC2A can here each have a bistable solenoid valve 10A, 10B, 10C, not shown in greater detail, which has a de-energized closed position and a de-energized open position and can be switched between the two positions. Thus, for example, in each case a first bistable solenoid valve 10A, 10B, 10C can be so seated in the respective brake circuit that, in the de-energized open position, it releases the brake pressure regulation in at least one associated wheel brake RR, FL, FR, RL and, in the de-energized closed position, encloses a current brake pressure in the at least one associated wheel brake RR, FL, FR, RL. The first bistable solenoid valves 10A, 10B, 10C can be seated at different positions in the respective brake circuit BC1A, BC2A. Thus, the bistable solenoid valves 10A, 10B, 10C can be seated in the respective brake circuit BC1A, BC2A, for example, between the corresponding changeover valve USV1, USV2 and the inlet valves EV1, EV2, EV3, EV4 upstream of an outlet channel of the corresponding fluid pump RFP1, RFP2. Alternatively, the bistable solenoid valves 10A, 10B, 10C can in each case be seated in the respective brake circuit BC1A, BC2A between the master brake cylinder 5A and corresponding changeover valve USV1, USV2 directly upstream of the corresponding changeover valve USV1, USV2. As a further alternative arrangement, the bistable solenoid valves 10A, 10B, 10C can in each case be seated in the respective brake circuit BC1A, BC2A between the corresponding changeover valve USV1, USV2 and the inlet valves EV1, EV2, EV3, EV4 downstream of the outlet channel of the fluid pump RFP1, RFP2. In addition, in a further alternative arrangement, the bistable solenoid valves 10A, 10B, 10C can in each case be seated in the respective brake circuit BC1A, BC2A between the master brake cylinder 5A and the corresponding changeover valve USV1, USV2 in the common fluid branch directly downstream of the master brake cylinder 5A. Moreover, the bistable solenoid valves 10A, 10B, 10C can be seated in the respective brake circuit BC1A, BC2A in each case directly upstream of an associated wheel brake RR, FL, FR, RL.

In addition, in the exemplary embodiment shown, the two changeover valves USV1, USV2 and the two suction valves HSV1, HSV2 can in each case be in the form of a bistable solenoid valve 10A, 10B, 10C.

As can further be seen from FIG. 8, the second exemplary embodiment shown of the hydraulic braking system 1B has, in contrast to the first exemplary embodiment, a hydraulic pressure generator ASP, the pressure of which can be set via a servomotor APM, and a pedal simulator PFS. The pressure generator ASP can be charged with fluid from the fluid container 7B via a charging valve PRV. As can further be seen from FIG. 8, each brake circuit BC1B, BC2B is connected with the master brake cylinder 5B, which can be actuated via a brake pedal 3B. In addition, a fluid container 7B is connected with the chambers of the master brake cylinder 5B. A simulator valve SSV connects the pedal simulator PFS with the muscle-force-actuated master brake cylinder 5B in normal operation and isolates the pedal simulator PFS from the master brake cylinder 5B in the case of emergency operation, which is shown, and during brake pressure regulation. For brake pressure regulation and for implementing a TCS function and/or an ESP function, the hydraulic unit 9B uses the hydraulic pressure generator ASP, and in the first brake circuit BC1B a first brake circuit isolating valve CSV1 and a first pressure switching valve PSVT, and in the second brake circuit BC2B a second brake circuit isolating valve CSV2 and a second pressure switching valve PSV2. The pressure switching valves PSV1, PSV2 permit intervention in the braking system without a driver command being present. To that end, the pressure accumulator is connected via the pressure switching valves PSV1, PSV2 with at least one associated wheel brake RR, FL, FR, RL, so that it, instead of the driver, can provide the required pressure for the regulation. As can further be seen from FIG. 8, a first pressure switching valve PSV1 sets the system pressure or brake pressure in the first brake circuit BC1B, and a second pressure switching valve PSV2 sets the system pressure or brake pressure in the second brake circuit BC2B. In emergency operation, as is shown, the brake circuit isolating valves CSV1, CSV2 connect the muscle-force-actuated master brake cylinder 5B with at least one associated wheel brake RR, FL, FR, RL, and isolate the muscle-force-actuated master brake cylinder 5B from the at least one associated wheel brake RR, FL, FR, RL in normal operation and during brake pressure regulation. In normal operation and during brake pressure regulation, the pressure switching valves PSV1, PSV2 connect the hydraulic pressure generator ASP with the at least one associated wheel brake RR, FL, FR, RL, and in emergency operation isolate the hydraulic pressure generator ASP from the at least one associated wheel brake RR, FL, FR, RL. Furthermore, the hydraulic unit 9B comprises a plurality of sensor units, not shown in greater detail, for determining the current system pressure or brake pressure. In the exemplary embodiment shown, the simulator valve SSV and the two pressure switching valves PSV1, PSV2 and one of the two brake circuit isolating valves CSV1, CSV2 are in each case in the form of bistable solenoid valves 10A, 10B, 10C. Since with a bistable solenoid valve the current switching position is retained in the event of failure of the vehicle electrical system and the bistable solenoid valves could also be de-energized closed at that point in time, it is expedient for the exemplary embodiment shown to replace only one of the two brake circuit isolating valves CSV1, CSV2 by a bistable solenoid valve 10A, 10B, 10C, so that, in the event of failure of the vehicle electrical system, the vehicle can be braked by means of a brake circuit BC1B, BC2B, since the conventional brake circuit isolating valve is in the form of a de-energized open solenoid valve and is held in the open position by its return spring.

In the hydraulic braking system 1B shown, the brake pressure in normal driving operation is not normally generated by a vacuum brake booster, assisted by the driver's foot, but via the engine-operated pressure generator ASP. When the driver actuates the brake pedal 3B, this braking command is sensed by the system via corresponding sensor units, not shown, and the simulator valve SSV and the pressure switching valves PSV1, PSV2 and the brake circuit isolating valves CSV1, CSV2 are switched simultaneously. The simulator valve SSV is changed from the de-energized closed position into the de-energized open position. The driver thereby displaces volume into the pedal simulator PFS, and the driver receives haptic feedback via the braking operation. The two brake circuit isolating valves CSV1, CSV2 are changed from the de-energized open position into the de-energized closed position, whereby the brake lines from the master brake cylinder 5B are blocked. The pressure switching valves PSV1, PSV2 are changed from the de-energized closed position into the de-energized open position, whereby the brake lines from the pressure generator ASP to the brake circuits BC1B, BC2B are opened and the pressure generator ASP is able to set the desired brake pressure for each individual wheel via the servomotor APM.

1. A bistable solenoid valve for a hydraulic braking system, comprising:
a magnet assembly;
a guide sleeve;
a stationary component is fixedly arranged in the guide sleeve, the magnetic assembly pushed onto the stationary component and the guide sleeve; and
a valve armature arranged in an axially displaceable manner in the guide sleeve, the valve armature having a permanent magnet and, at a first end facing the stationary component, a magnet receiver configured to receive the permanent magnet, the permanent magnet polarized in a movement direction thereof,
wherein the stationary component defines an axial stop for the valve armature, and wherein the valve armature is configured to be driven by a magnetic force generated by the magnet assembly or by a magnetic force of the permanent magnet and pushes a closing element into a valve seat during a closing movement and lifts the closing element out of the valve seat during an opening movement.

2. The bistable solenoid valve as claimed in claim 1, wherein the guide sleeve is open at both ends, and wherein the stationary component is a pole body that closes the guide sleeve at a first end.

3. The bistable solenoid valve as claimed in claim 2, wherein the guide sleeve is connected at a second end with a dome-shaped valve sleeve at a bottom of which the valve seat is defined at an edge of a through-opening.

4. The bistable solenoid valve as claimed in claim 2, wherein the permanent magnet remains on the pole body in a de-energized open position of the solenoid valve so that an air gap between the pole body and the valve armature is minimal and the closing element is lifted from the valve seat.

5. The bistable solenoid valve as claimed in claim 2, wherein the magnet assembly is energized during the closing movement with a first current direction, which generates a first magnetic field, which causes the pole body to repel the permanent magnet with the valve armature, so that an air gap between the valve armature and the pole body becomes larger and the closing element is pushed into the valve seat.

6. The bistable solenoid valve as claimed in claim 2, wherein a return spring is arranged between the pole body and the valve armature, and wherein a spring force of the return spring assists the closing movement.

7. The bistable solenoid valve as claimed in claim 6, wherein, in a de-energized closed position of the solenoid valve, one or more of a pressure confined in the solenoid valve andr the return spring hold the closing element in a sealing manner in the valve seat.

8. The bistable solenoid valve as claimed in claim 2, wherein, during the opening movement, the permanent magnet moves the valve armature in a direction towards the pole body, when a pressure confined in the solenoid valve falls below a settable limit value, so that an air gap between the valve armature and the pole body becomes smaller and the closing element is lifted out of the valve seat.

9. The bistable solenoid valve as claimed in claim 2, wherein, during the opening movement, the magnet assembly is energized with a second current direction, which generates a second magnetic field, which causes the pole body and the permanent magnet with the valve armature to attract one another, so that an air gap between the valve armature and the pole body becomes smaller and the closing element is lifted out of the valve seat.

10. The bistable solenoid valve as claimed in claim 9, wherein the magnetic force of the permanent magnet is smaller than an acting closing force generated by one or more of a pressure confined in the solenoid valve and a return spring arranged between the pole body and the valve armature.

11. The bistable solenoid valve as claimed in claim 1, wherein the guide sleeve is configured as a capsule open at one end, and the stationary component is a valve insert onto which the guide sleeve is pushed with its open end, the valve insert having a through-opening.

12. The bistable solenoid valve as claimed in claim 11, wherein the valve armature is arranged between the valve insert and a closed end of the guide sleeve and has at a first end face a plunger that is guided in the through-bore of the valve insert, wherein the closing element is arranged at a side of the valve insert that is remote from the valve armature, and wherein at a second end of the valve insert a dome-shaped valve sleeve is inserted into the through-opening, at the closed end of which the valve seat is formed at an edge of a through-opening.

13. The bistable solenoid valve as claimed in claim 11, wherein the permanent magnet remains on the valve insert in a de-energized closed position of the solenoid valve, so that an air gap between the valve insert and the valve armature is minimal and the closing element rests in a sealing manner in the valve seat.

14. The bistable solenoid valve as claimed in claim 11, wherein the magnet assembly is energized during the opening movement with a second current direction, which generates a second magnetic field, which causes the valve insert to repel the permanent magnet with the valve armature, so that an air gap between the valve armature and the valve insert becomes larger and the closing element is lifted from the valve seat.

15. The bistable solenoid valve as claimed in claim 11, wherein there is arranged in the through-bore of the valve insert a return spring that is supported at one end on a spring receiver and at the other end acts via the plunger on the valve armature, so that a spring force of the return spring assists the opening movement.

16. The bistable solenoid valve as claimed in claim 15, wherein, in a de-energized open position of the solenoid valve, one or more of a fluidic force acting in the solenoid valve and the return spring hold the closing element in a position lifted from the valve seat.

17. The bistable solenoid valve as claimed in claim 16, wherein, during the closing movement, the permanent magnet moves the valve armature in a direction towards the valve insert, when the fluidic force acting in the solenoid valve falls below a settable limit value, so that an air gap between the valve armature and the valve insert becomes smaller and the closing element is pushed into the valve seat.

18. The bistable solenoid valve as claimed in claim 12, wherein, during the closing movement, the magnet assembly is energized with a first current direction, which generates a first magnetic field, which causes the valve insert and the permanent magnet with the valve armature to attract one another, so that an air gap between the valve armature and the valve insert becomes smaller and the closing element is pushed into the valve seat.

19. The bistable solenoid valve as claimed in claim 18, wherein the magnetic force of the permanent magnet is smaller than an acting opening force generated by one or more of a fluid force acting in the solenoid valve and a return spring.

20. The bistable solenoid valve as claimed in claim 1, wherein the permanent magnet is arranged within the magnet assembly independently of a stroke of the valve armature.

21-26. (canceled)
